(19) United States
(12) Patent Application Publication
(10) Pub. No.: US 2005/0268306 A1
(43) Pub. Date: Dec. 1, 2005

(54) Method and system for presenting actions associated with a managed object in a task context

(76) Inventors: Mark S. Anspach, Wellington, CO (US); Evelyn L. Williams, Longmont, CO (US); Rock D. Barney, Fort Collins, CO (US); Robert Raymond, Ft Collins, CO (US)

Correspondence Address: HEWLETT-PACKARD COMPANY;Intellectual Property Administration, P.O. Box 272400, Fort Collins, CO, 80527-2400, US

(21) Appl. No.: 11/135,460

(22) Filed: May 24, 2005

Related U.S. Application Data
(60) Provisional application No. 60/573,952, filed on May 25, 2004.

(51) Int. Cl. G06F 9/44

(52) U.S. Cl. 719/313; 719/316

(57) ABSTRACT

A method and system are described for presenting actions associated with a managed object in a task context. According to an exemplary method, access to a plurality of task domains associated with the object is provided through a shared user interface. A portion of the actions associated with the object directly related to a task domain is identified. The portion of the actions directly related to the task domain is presented using a first element of the user interface, such as a context menu displayable near a location of a representation of the object within the user interface. A software link is provided between the first element and a second element of the user interface, such as a dialog box, configured to present a remaining portion of the actions associated with the object.

### BACKGROUND

A goal in creating a usable graphical user interface (or GUI) for a software application is to structure application features and capabilities according to a task model that is intuitive to a user. Doing so can allow the user to perform tasks for their job or role without having to first translate their goals and anticipated tasks to match the application's particular user interface.

Navigation, object grouping, and menu/action groupings in a GUI are generally arranged to match a typical-use (or core-use) model for targeted users. GUI designs that employ data level integration and object-model-driven interfaces tend to focus on the objects being managed through the interface, rather than on the actions available to those objects. Consequently, GUIs created on top of object models often focus on object groups to provide the core-use model for the interface.

In one example of an object-model-driven interface, the representations of objects that are similar in type to one another are arranged adjacently in the interface. Access to all actions associated with each object is provided through the interface. Applying this example to a network management environment, network devices can be arranged by type, e.g., routers, switches, hubs, and the like. For each object type, an number of actions for managing the object are provided, including network connectivity, software and services, backup and recovery, asset management, change management, and the like. All of the actions can be provided in a single menu for each object instance. Such an arrangement can be useful, as the arrangement provides that all actions currently registered for an object are available from any representation of an object instance presented in the GUI.

Object-model-driven interface designs work well when the set of actions for the objects is homogeneous. As complexity of the action set increases, users can have difficulty in sorting through the available object functionality when deciding how to best utilize an action set's capabilities to accomplish task goals. For example, menu lists can become lengthy, which can dramatically increase the search time for locating appropriate features. This can be a challenge when designing shared GUIs for an integrated set of application programs, such as Hewlett Packard's OpenView product family. As new products that support different task domains are integrated into a common object-model-driven GUI console, the need to organize functionality according to user task domains grows.

Some have addressed this challenge by designing application suites that incorporate minimal GUI integration between the various product offerings of the suite. This can require users to “launch” separate GUIs to act on an object and access the features of a secondary product. Because these separate interfaces are themselves organized by object type groups, the action set within a particular product can be kept homogeneous, allowing these designers to avoid the issues of task-based GUI design to produce a heterogeneous task set.

### SUMMARY

Accordingly, a method and system are disclosed for presenting actions associated with a managed object in a task context. According to an exemplary method, access to a plurality of task domains associated with the object is provided through a shared user interface. A portion of the actions associated with the object directly related to a task domain is identified. The portion of the actions directly related to the task domain is presented using a first element of the user interface. A software link is provided between the first element and a second element of the user interface configured to present a remaining portion of the actions associated with the object.

According to another exemplary embodiment, a system is described for presenting actions associated with a managed object in a task context. The system includes a display configured to display a shared user interface. The shared user interface is configured to provide access to a plurality of task domains associated with the object. The system includes a processor coupled to the display. The processor includes logic configured to identify a portion of the actions associated with the object directly related to a task domain. Additional logic in the processor is configured to present the portion of the actions directly related to the task domain using a first element of the user interface. The processor further includes logic configured to provide a software link between the first element and a second element of the user interface configured to present a remaining portion of the actions associated with the object.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 illustrates a system for presenting actions associated with a managed object in a task context, according to an exemplary embodiment;

FIG. 2 illustrates an exemplary dialog box for presenting object actions used in conjunction with the exemplary system shown in FIG. 1; and

FIG. 3 is a flowchart illustrating a method for presenting actions associated with a managed object in a task context, according to an exemplary embodiment.

### DETAILED DESCRIPTION

Various aspects will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both.

Thus, the various aspects can be embodied in many different forms, and all such forms are contemplated to be within the scope of what is described. For each of the various aspects, any such form of embodiment can be referred to here as “logic configured to” perform, or “logic that” performs a described action.

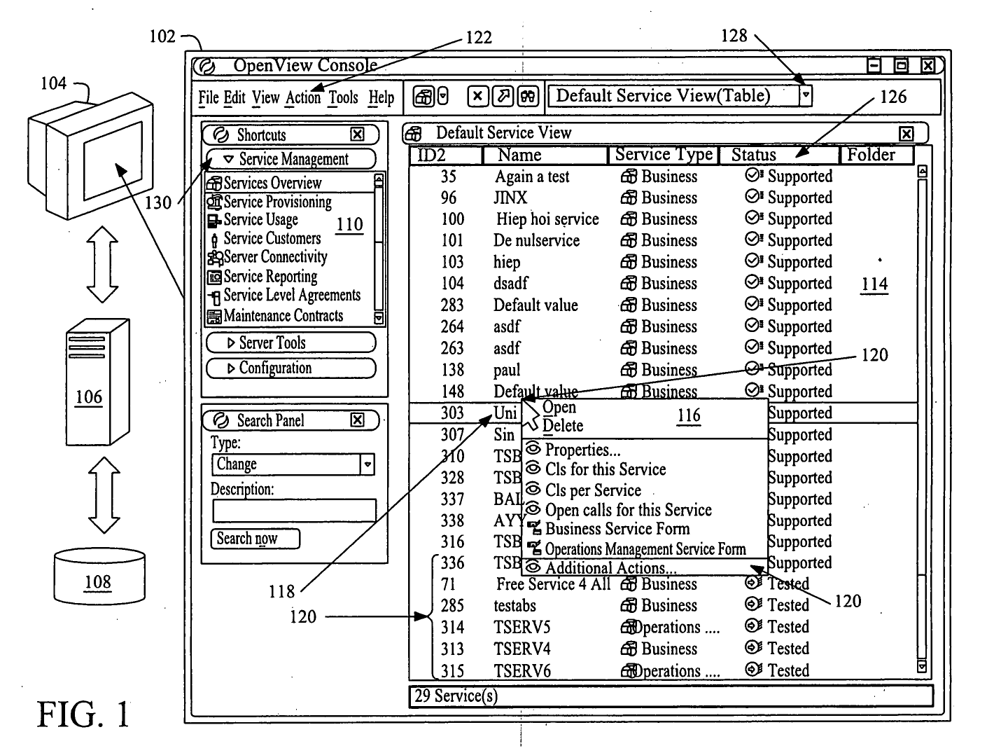

A system for presenting actions associated with a managed object in a task context according to an exemplary embodiment is shown in FIG. 1. The object can managed within a data model of managed system. As understood by the skilled software artisan, a data model can be used define the information contained in a database, such as database 108 shown in FIG. 1, how the information will be used, and how the items in the database 108 will be related to each other.

A data model that captures object-oriented programming concepts can be referred to as an object model. An object model can include a number of objects used by various application programs to perform object-related tasks. In this context, an object can be a software bundle of variables (e.g., attributes and data) and related methods. The methods can be carried out using software programs or code associated with the object. Software objects can be used to model real-world objects, such as routers, switches, hubs, and other network devices. An object model defines the structure of the objects included within a system, including their identity (or class), variables, methods, and associations with other objects in the system. The terms object model and data model are used interchangeably throughout this document.

Various application programs can reference the different objects of an object model to perform actions for carrying out respective tasks. The actions can be the methods of an object itself, or can include the methods of several objects needed to carry out the task. Object models can be said to be extensible, as new variables and methods can be added to the objects of a particular object class to support the tasks of new application programs. Typically, the variables and methods of an object used by a particular application program are visible (or available) to only that program, e.g., through the particular application program's GUI. Consequently, the actions performed using those variables and methods can be visible only through that application program's particular GUI as well.

The system of FIG. 1 includes means, such as a shared user interface, for providing access to a plurality of task domains associated with the object. The means can include the GUI 102, display 104, and processor 106 shown in the figure that can serve as a shared user interface for each of the task domains. As used here, a task domain can include any number of tasks associated with the object that share a common task theme or central functionality. Task domains, and the various tasks that they include, can be defined when structuring the data model 108. A task domain can include the tasks of only one application program, or can include the tasks of several application programs that are integrated into the shared user interface 102. The shared user interface or GUI 102 is displayable on the display 104, and is configured to provide access to a plurality of task domains associated with the object. Access to these different task domains can be provided using a shortcut menu 110 included in the GUI 102.

For example, the GUI 102 can be configured to provide access to a number of task domains associated with network objects (e.g., routers, switches, hubs, and the like), such as the “Services Overview”, “Service Provisioning”, “Service Usage”, “Service Customers”, “Server Connectivity”, “Service Reporting”, “Service Level Agreements”, and “Maintenance Contracts” task domains shown in FIG. 1.

As the different tasks associated with an object that share a common task theme or central functionality can be grouped into a task domain, the different task domains that share a common functional theme or relationship can be further grouped into a task domain group. For example, the task domains described above can be said to share a common service relationship, and can be grouped into a “Service Management” task domain group 130 as shown in the figure. While certain task domains-can be grouped into several task domain groups 130 (e.g., the “Server Connective” task domain can also be included in the “Server Tools” task domain group), care should be taken not to “overload” the user by providing too many access points to a particular task domain through the shared user interface.

As described above, various application programs can be integrated into the shared user interface 102 and can reference the different objects of the data model 108 to perform actions for carrying out respective tasks. The actions for the objects used by a particular application program can be registered, e.g., by the processor 106 operating as an object server, at a time when the particular application program is integrated into the shared user interface 102.

The system of FIG. 1 can include means, such as the processor 106 coupled to the display 104 and the data model 108, for identifying a portion of the actions associated with the object directly related to a task domain. The processor 106 includes logic configured to identify the portion of the actions associated with the object directly related to a task domain. Various ways in which the processor logic can determine the portion of the actions directly related to the task domain will now be described in the context of the following example.

Consider the exemplary GUI 102 shown in FIG. 1 in which a “Services Overview” task domain, or simply a Service task domain, is shown to be selected. Representations (e.g., symbols, list items, and the like) 112 of a number of objects can be presented in a portion of the GUI 102, e.g., using the extended list box 114 shown in the figure. For the purpose of describing features of the GUI 102, the terms “representation” and “object” will be used interchangeably, but the informed reader will recognize the distinction between these terms. In the example, the processor logic has identified from a list of all actions registered for the objects 112 shown in FIG. 1 that each of a “Properties . . .”, “CIs for this Service” (where “CI” stands for “Configuration Item”), “CIs per Service”, “Open call for this Service”, Business Service Form”, and “Operations Management Service Form” action are directly related to the Service task domain.

The logic included in the processor 106 can identify the portion of actions directly related to a task domain when the objects used by a particular application program are registered by the processor 106 (e.g., when the processor 106 is operating as an object server). For example, when a task domain includes tasks performed by only one application program, the processor logic can identify all of the actions associated with objects registered for, and visible to, that application program as being “directly related” to the task domain.

Alternatively, when the task domain includes the tasks of several application programs that are integrated into the shared user interface 102, the data model 108 can be structured to allow the processor 106 to determine which actions are “directly” related to a task domain. For example, the objects included in the data model 108 can include variables that can be evaluated by the processor logic in determining to which task domain(s) related methods and/or actions belong. In addition, certain users (e.g., network or OpenView administrators) can have the ability to define/redefine the actions that are “directly” related to a task domain, or the task domains and task domain groups themselves, using configuration files that can be interpreted by the processor logic to control the manner in which the processor 106 interacts with the data model 108.

The system shown in FIG. 1 further includes means for presenting the portion of the actions directly related to the task domain. For example, the processor 106 can include logic configured to present the portion of the actions directly related to the task domain using means, such as a first element of the user interface. The first element can be a menu, such as a context menu 116 as shown in FIG. 1. Such context menus 116 (also referred to as “pop-up” or “shortcut” menus) can be displayable near a location , e.g. a name 118, of the representation of the object 112 within the user interface 102. The system can also include means for including each action of the portion of the actions directly related to the task domain as an item in the menu. For example, the processor 106 can include logic configured to include each of the “Properties . . .”, “CIs for this Service”, “CIs per Service”, “Open call for this Service”, Business Service Form”, and “Operations Management Service Form” actions in the context menu 116 as shown in FIG. 1.

The system of FIG. 1 also includes means for providing access from the presented portion of the actions directly related to the task domain to a remaining portion of the actions associated with the object. For example, the processor 106 can include logic configured to provide a software link between a first element, such as the context menu 116, and a second element of the user interface. Additional logic in the processor 106 can be configured to include a linking item in the menu, such as the “Additional Actions . . .” item 120 shown in the figure. Logic included in the processor 106 can also be configured to associate the software link with the linking item 120, and then to display the menu in response to activating a user interface control.

The user interface control can include a representation of the object, e.g., the object name 118 shown in FIG. 1. The user interface control can be activated by positioning a pointer, such as the arrow 124 shown, over a representation of the object, e.g., the name 118, using a pointing device, such as a mouse (not shown). Activating a control on the pointing device, e.g., “right-clicking” the mouse, while the pointer is positioned over the representation 118 of the object can activate the user interface control. For example, a menu, such as the context menu 116, including the actions directly related to the task domain, can be displayed near a location of the representation of the object, e.g., near the name 118, within the user interface in response to “right-clicking” the mouse over the representation 118.

The user interface control can also include a menu bar item included in the user interface, such as the “Action” menu bar item 122 shown in FIG. 1. The pointer 124 can be positioned over the menu bar item, e.g., the “Action” menu bar item 122, while activating a control on the pointing device, e.g., “left-clicking” the mouse. A menu (not shown) similar to the context menu 116, including the actions directly related to the task domain, can then be displayed near a location of the menu bar item 122 in response to “left-clicking” the mouse over the menu bar item 122. While the activation of the user interface control has been described above in conjunction with the use of a pointing device, such as a mouse, persons skilled in the art will understand that other techniques, such as using keyboard controls (e.g., tab, arrow, and enter keys), can be used to activate the user interface control.

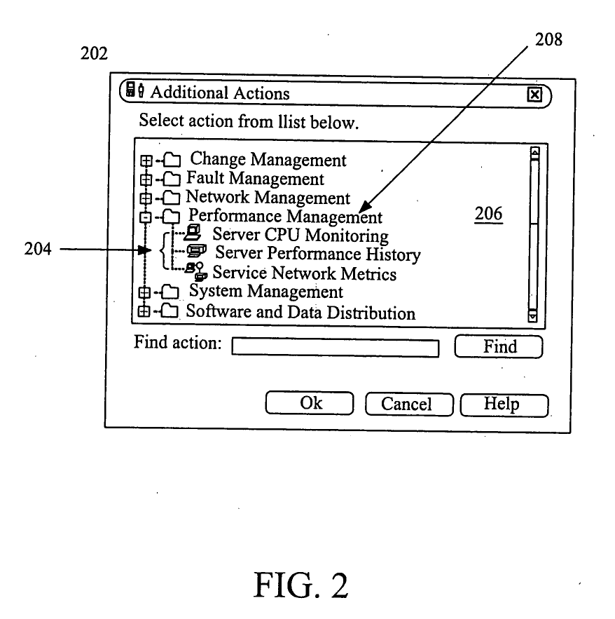

According to an exemplary embodiment, the second element can be a dialog box, such as the dialog box 202 shown in FIG. 2. The system can include means for including each action of the remaining portion of the actions associated with the object in a list displayable within the dialog box. For example, the processor 106 can include logic configured to include the remaining portion of the actions associated with the object, such as the “Server CPU Monitoring”, “Server Performance History”, and “Service Network Metrics” actions 204. The remaining portions of actions 204 can be included in a list, such as the extended list box 206 shown in FIG. 2, that is displayable within the dialog box 202.

The system can include means for associating the software link with the dialog box and means for displaying the dialog box in response to activating a control associated with the linking item. For example, the processor 106 can include logic configured to associate the software link with the dialog box 202, resulting in a software link between the linking item included in the menu, e.g., the “Additional Actions . . .” item 120 included in the context menu 116, and the dialog box 202.

The processor 106 can include logic configured to display the dialog box 202 when a control associated with the linking item is activated. For example. the pointer 124 can be positioned over the “Additional Actions . . .” linking item 120 of the context menu 116 using a mouse, while activating a control on the pointing device, e.g., either “left-clicking” or “right-clicking” the mouse. The dialog box 202, including the remaining portion of the actions 204, can then be displayed in response to activating the control associated with the linking item 120. Although the dialog box 202 shown in FIG. 2 is depicted as being “separate” from the GUI 102 shown in FIG. 1, it will be understood that the dialog box 202 can be displayed with a presentation space of the GUI 102.

The remaining portion of the actions 204 displayable with the dialog box 202 can be organized into groups based on a task domain to which the remaining actions 204 directly relate. The groups can have headings 208 corresponding to name of the task domain, e.g., “Performance Management” to which the remaining actions 204 directly relate. Additional controls, such as the “Find”, “Ok”, and “Cancel” buttons, can be included in the dialog box 202 to navigate and manipulate the remaining actions 204.

The system can also include means for arranging the representation of the object within the user interface 102 based on an attribute of the task domain. For example, the processor 106 can include logic configured to arrange the object representations 112 within the extended list box 114 in an order according to a status attribute 126, having the values “supported”, “unsupported”, and “tested”. The attribute used to arrange the representation of the object with the user interface 102 can depend on a selected task domain view. For example, in FIG. 1, a table view for the Service task domain is selected using the view control 128.

According to an exemplary embodiment, the system can include memory (not shown) coupled to the processor 106. The memory can be configured to store program instructions for a plurality of application programs. Each application program can be controllable using the shared user interface, such as the GUI 102. The application programs can be configured to perform tasks associated with the object corresponding to a respective task domain.

The system described above in conjunction with FIGS. 1 and 2 can allow a GUI to be structured according to a task-based organization, even though the data and methods of various application programs integrated into the GUI are managed by an object-based server. Consequently, users can have the actions most relevant to a particular task made more readily available to them, e.g. using menus such as the context menu 116. Access to other actions that are not directly related to the task at hand can be provided through a more removed action-selection interface, such as the dialog box 202.

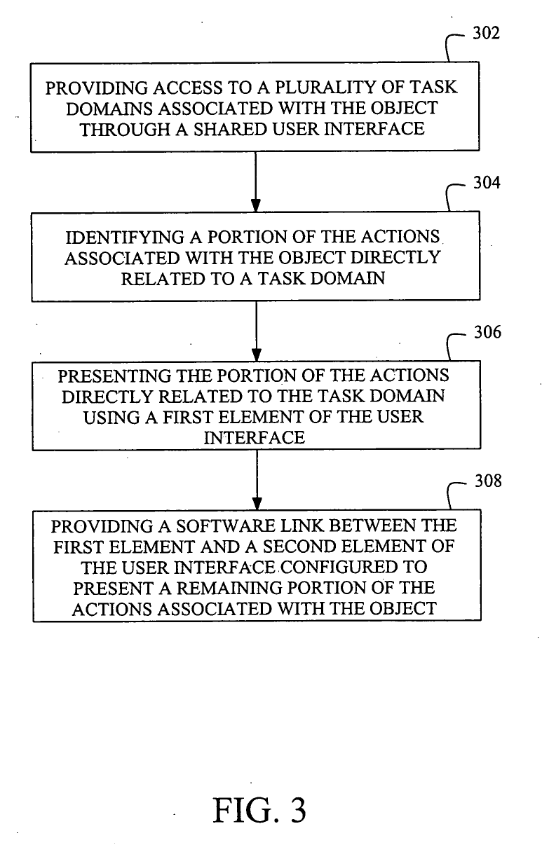

FIG. 3 depicts a flowchart illustrating an exemplary method for presenting actions associated with a managed object in a task context. The method can be carried out using the exemplary system depicted in FIGS. 1 and 2 as described above. The method begins in block 302, where access to a plurality of task domains associated with the object is provided through a shared user interface, such as the GUI 102 shown in FIG. 1. As described above, each task domain can include a plurality of related tasks associated with the object. Moreover, each task domain can be associated with a respective application program controllable using the shared user interface, such as the GUI 102, but a task domain can include the tasks of several application programs as well.

In block 304, a portion of the actions associated with the object directly related to a task domain is identified. The portion of the actions directly related to the task domain can be identified using the processor 106, as described in detail above. Next, in block 306, the portion of the actions directly related to the task domain is presented using a first element of the user interface. The first element can be a menu, such as the context menu 116 describe above. In block 308, a software link is provided between the first element and a second element of the user interface configured to present a remaining portion of the actions associated with the object. The second element can be a dialog box 202, such as that described above in conjunction with FIG. 2.

According to an exemplary embodiment, the portion of the actions directly related to the task domain can be present using the first element by including each action of the portion of the actions as an item in a menu associated with the object. For example, the “Properties . . .”, “Cls for this Service”, “Cls per Service”, “Open call for this Service”, Business Service Form”, and “Operations Management Service Form” actions directly related to a Service task domain can be included in the context menu 116, as described above in conjunction with the embodiment shown in FIG. 1.

A linking item can be included in the menu, such as the “Additional Actions . . . ” item 120 shown in FIG. 1. The software link can be associated with the linking item, and the menu displayed in response to activating a user interface control. Activating the user interface control can include positioning a pointer over a representation of the object included in the user interface using a pointing device. For example, the arrow 124 can be positioned over the name 118 of the object included in the extended list box 114. A control on the pointing device can be activated, e.g., by “right-clicking” a mouse, while the pointer is positioned over the representation of the object to display the menu, e.g., the context menu 116. The pointer can also be positioned over a menu bar item, e.g., the “Action” menu bar item 122 shown in FIG. 1, and the control on the pointing device activated, e.g. by “left-clicking the mouse”, to display the menu.

According to an exemplary embodiment, each action of the remaining portion of the actions associated with the object can be included in a list displayable within a dialog box. For example, the remaining portions of the actions 204 can be included in the extended list box 206 of the dialog box 202, as shown in FIG. 2. The software link can be associated with the dialog box 202 to establish a link between the “Additional Actions . . .” linking item 120 and the dialog box 202. The dialog box can then be displayed, e.g. on the display 104 in response to activating a control associated with the linking item. Activating the control associated with the linking item can include positioning a pointer over the linking item included in the menu using a pointing device, and activating a control on the pointing device while the pointer is positioned over the linking item. For example, the arrow 124 can be positioned over the “Additional Actions . . .” linking item 120, and a control on the pointing device activated, e.g., by “left-clicking” or “right-clicking” the mouse, to display the dialog box 202.

A representation of the object can be arranged within the user interface based on an attribute of the task domain. For example, the object representations 112 shown in FIG. 1 can be arranged within the extended list box 114 in an order according to a status attribute 126, having the values “supported”, “unsupported”, and “tested”. The attribute used to arrange the representation of the object with the user interface 102 can depend on a selected task domain view. For example, in FIG. 1, a table view for the Service task domain is selected using the view control 128.

The executable instructions of a computer program as illustrated in FIG. 2 for presenting actions associated with a managed object in a task context can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium, such as the removable storage device 116 shown in FIG. 1. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A method for presenting actions associated with a managed object in a task context, the method comprising:
providing access to a plurality of task domains associated with the object through a shared user interface;
identifying a portion of the actions associated with the object directly related to a task domain;
presenting the portion of the actions directly related to the task domain using a first element of the user interface; and
providing a software link between the first element and a second element of the user interface configured to present a remaining portion of the actions associated with the object.

2. The method of claim 1, wherein presenting the portion of the actions directly related to the task domain using a first element of the user interface comprises:
including each action of the portion of the actions directly related to the task domain as an item in a menu associated with the object;
including a linking item in the menu;
associating the software link with the linking item; and
displaying the menu in response to activating a user interface control.

3. The method of claim 2, wherein activating a user interface control comprises:
positioning a pointer over a representation of the object included in the user interface using a pointing device; and
activating a control on the pointing device while the pointer is positioned over the representation of the object.

4. The method of claim 3, wherein the menu is a context menu displayable near a location of the representation of the object within the user interface.

5. The method of claim 2, wherein activating a user interface control comprises:
positioning a pointer over a menu bar item included in user interface; and
activating a control on the pointing device while the pointer is positioned over the menu bar item.

6. The method of claim 2, comprising:
including each action of the remaining portion of the actions associated with the object in a list displayable within a dialog box;
associating the software link with the dialog box; and
displaying the dialog box in response to activating a control associated with the linking item.

7. The method of claim 6, wherein activating a control associated with the linking item comprises:
positioning a pointer over the linking item included in the menu using a pointing device; and
activating a control on the pointing device while the pointer is positioned over the linking item.

8. The method of claim 1, comprising:
arranging a representation of the object within the user interface based on an attribute of the task domain.

9. The method of claim 1, wherein each task domain comprises a plurality of related tasks associated with the object.

10. The method of claim 1, wherein each task domain is associated with a respective application program controllable using the shared user interface.

11. The method of claim 1, wherein each task domain includes tasks associated with a plurality of application programs, each application program controllable using the shared user interface.

12. A system for presenting actions associated with a managed object in a task context, the system comprising:
a display;
a shared user interface displayable on the display, the user interface configured to provide access to a plurality of task domains associated with the object; and
a processor coupled to the display, the processor including:
logic configured to identify a portion of the actions associated with the object directly related to a task domain;
logic configured to present the portion of the actions directly related to the task domain using a first element of the user interface; and
logic configured to provide a software link between the first element and a second element of the user interface configured to present a remaining portion of the actions associated with the object.

13. The system of claim 12, wherein the first element is a menu and the processor comprises:
logic configured to include each action of the portion of the actions directly related to the task domain as an item in the menu;
logic configured to include a linking item in the menu;
logic configured to associate the software link with the linking item; and
logic configured to display the menu in response to activating a user interface control.

14. The system of claim 13, wherein the user interface control comprises at least one of a representation of the object and a menu bar item included in the user interface.

15. The system of claim 14, wherein the menu is a context menu displayable near a location of the representation of the object within the user interface.

16. The system of claim 13, wherein the second element is a dialog box and the processor comprises:
logic configured to include each action of the remaining portion of the actions associated with the object in a list displayable within the dialog box;
logic configured to associate the software link with the dialog box; and
logic configured to display the dialog box in response to activating a control associated with the linking item.

17. The system of claim 12, wherein the processor comprises:
logic configured to arrange a representation of the object within the user interface based on an attribute of the task domain.

18. The system of claim 12, comprising:
memory coupled to the processor, the memory configured to store program instructions for a plurality of application programs, each application program being controllable using the shared user interface and configured to perform tasks associated with the object corresponding to a respective task domain.

19. A system for presenting actions associated with a managed object in a task context, the system comprising:
means for accessing a plurality of task domains associated with the object;
means for identifying a portion of the actions associated with the object directly related to a task domain; means for presenting the portion of the actions directly related to the task domain; and
means for providing access from the presented portion of the actions directly related to the task domain to a remaining portion of the actions associated with the object.

20. The system of claim 19, comprising:
means for including each action of the portion of the actions directly related to the task domain as an item in a menu associated with the object;
means for including a linking item in the menu;
means for associating a software link with the linking item; and
means for displaying the menu in response to activating a user interface control.

21. The system of claim 20, wherein the user interface control comprises at least one of a representation of the object and a menu bar item included in the user interface.

22. The system of claim 21, wherein the menu is a context menu displayable near a location of the representation of the object within the user interface.

23. The system of claim 20, comprising:
means for including each action of the remaining portion of the actions associated with the object in a list displayable within a dialog box;
means for associating the software link with the dialog box; and
means for displaying the dialog box in response to activating a control associated with the linking item.

24. The system of claim 19, comprising:
means for arranging the object within the user interface based on an attribute of the task domain.

25. A computer readable medium containing a computer program for presenting actions associated with a managed object in a task context, wherein the computer program comprises executable instructions for:
providing access to a plurality of task domains associated with the object through a shared user interface;
identifying a portion of the actions associated with the object directly related to a task domain;
presenting the portion of the actions directly related to the task domain using a first element of the user interface; and
providing a software link between the first element and a second element of the user interface configured to present a remaining portion of the actions associated with the object.

26. The computer readable medium of claim 25, wherein the computer program comprises executable instructions for:
including each action of the portion of the actions directly related to the task domain as an item in a menu associated with the object;
including a linking item in the menu;
associating the software link with the linking item; and
displaying the menu in response to activating a user interface control.

27. The computer readable medium of claim 26, wherein the computer program comprises executable instructions for:
including each action of the remaining portion of the actions associated with the object in a list displayable within a dialog box;
associating the software link with the dialog box; and
displaying the dialog box in response to activating a control associated with the linking item.

28. The computer readable medium of claim 25, wherein the computer program comprises executable instructions for:
arranging a representation of the object within the user interface based on an attribute of the task domain.

29. The computer readable medium of claim 25, wherein the computer program comprises executable instructions for:
a plurality of application programs, each application program being controllable using the shared user interface and configured to perform tasks associated with the object corresponding to a respective task domain.
